(19) United States
(12) Patent Application Publication
(10) Pub. No.: US 2003/0051966 A1
(43) Pub. Date: Mar. 20, 2003

(54) Clutch assembly

(76) Inventors: James N. Sproatt, Elkhart, IN (US); Mark M. Eichhorn, Mishawaka, IN (US); Clark W. Clark, Mishawaka, IN (US); Todd A. Stahly, Bremen, IN (US)

Correspondence Address: BARNES & THORNBURG, 600 ONE SUMMIT SQUARE, FORT WAYNE, IN, 46802

(21) Appl. No.: 10/196,640

(22) Filed: Jul. 16, 2002

Related U.S. Application Data
(60) Provisional application No. 60/306,039, filed on Jul. 17, 2001.

(51) Int. Cl. F16D 7/08

(52) U.S. Cl. 192/56.55; 464/36

(57) ABSTRACT

A clutch assembly is provided. The assembly has a rotatable member having a pathway disposed thereon which has at least one rise adjacent at least one vale. A retainer is provided which receives at least a portion of the at least one bearing. The bearing moves along the pathway and the retainer maintains receipt of at least a portion of the at least one bearing. The bias member is located adjacent at least a portion of the at least on bearing such that bias from the bias member is directed against the at least one bearing to maintain the at least one bearing substantially on the pathway.

### RELATED APPLICATIONS

The present application is related to and claims priority to U.S. Provisional Patent Application, Serial No. 60/306,039, filed on Jul. 17, 2001, entitled “ELECTRIC POWERED TRANSMISSION ASSEMBLY.” The subject matter disclosed in that provisional application is hereby expressly incorporated into the present application.

### TECHNICAL FIELD

The present disclosure is directed to clutch or coupling assemblies, and more particularly to clutch or coupling assemblies between driving and driven members that disengage when the driving torque reaches a threshold.

### BACKGROUND AND SUMMARY

Clutches used for preventing torque overload of driven members are known in the art. Such clutches, however, employ mechanisms that create excessive hammering. The hammering is the result of a structure, typically a bearing, impacting another structure, sometimes violently, in the clutch assembly during overloading of same. Repetitive impacts between structures during such excessive hammering over the long term may cause premature wear or damage to the clutch components, particularly at heavy loads.

It would, therefore, be beneficial to provide a clutch assembly that would reduce the effects of excessive hammering.

Accordingly, an illustrative embodiment disclosed herein provides a clutch assembly comprising first and second rotatable members, at least one bearing, a retainer, and a bias member. The first rotatable member comprises a pathway disposed thereon which has at least one rise adjacent at least one vale. The second rotatable member is engagable with the first rotatable member such that a portion of the bearing is positioned on the circular pathway and is movable along the pathway. The retainer is attached to the second rotatable member such that the retainer receives at least a portion of the at least one bearing. The bearing moves along the pathway and the retainer maintains receipt of at least a portion of the at least one bearing. The bias member is located adjacent at least a portion of the at least one bearing such that bias from the bias member is directed against the at least one bearing to maintain the at least one bearing substantially on the pathway.

Other illustrative embodiments of the clutch assembly may comprise the bias member being a disk spring; the bias created by the bias member being adjustable; the pathway being a circular pathway disposed on the first rotatable member; the at least one bearing being movable along the rise of the pathway as torque is applied to the assembly; the pathway having a peak located adjacent the rise, wherein the at least one bearing traverses the peak when a maximum torque for the assembly is reached; the pathway having a plurality of successive vales, rises and peaks.

Another illustrative embodiment disclosed herein provides a clutch assembly comprising first and second bodies and a wedge assembly. The first body is movable relative to the second body. The wedge assembly comprises a base wedge, a bias member and a bearing. The base wedge portion is an inclined plane that is located adjacent the first body, and has a bias force directed toward the base wedge portion. The bearing is positioned between the base wedge portion and the bias member. A force is exerted on the bearing caused by movement of the first body which causes the bearing to become movable along the inclined plane in resistance to the bias force of the bias member.

Other illustrative embodiments of this clutch assembly may comprise the bias member being a disk spring; the bias force created by the bias member being adjustable; the inclined plane defining a rolling pathway; the force exerted on the bearing being torque, such that as more torque is applied to the assembly, the more the bearing becomes movable along the inclined plane in resistance to the bias force of the bias member; the base wedge portion has a plurality of consecutively positioned basins, inclined planes, and peaks; and a peak located adjacent the rise, wherein the at least one bearing traverses the peak when a maximum torque for the assembly is reached.

Another illustrative embodiment disclosed herein provides a clutch assembly comprising first and second movable members, a bias structure, a means for the first movable member to selectively engage the second movable member, and a means for receiving the intermediate structure. The first movable member is movable relative to the second movable member. The intermediate member is located adjacent the first movable member, and the bias structure is located adjacent the intermediate member. The bias structure creates a bias force directed to the intermediate structure to maintain same adjacent the first movable member. The means for the first movable member to selectively engage the second movable member moves both first and second movable members concurrently. When a maximum threshold has been reached by the clutch assembly, the first and second movable members are disengaged without causing the intermediate member to disengage from the first movable member by the means for receiving the intermediate structure.

Other illustrative embodiments of this clutch assembly may comprise the means for receiving the intermediate structure and bias structure to prevent the intermediate structure from creating high impact forces against the first movable member when the clutch assembly reaches the maximum threshold; and the means for receiving the intermediate structure and bias structure prevents the intermediate structure from hammering when the clutch assembly reaches the maximum threshold.

Another illustrative embodiment disclosed herein provides a clutch assembly having a movable member comprising a circumferentially-oriented pathway disposed onto the movable member. The pathway comprises a basin portion, an incline portion located contiguous to the basin portion, and a peak portion located contiguous to the incline portion.

Other illustrative embodiments of this clutch assembly may comprise the circumferentially-oriented pathway further comprising a decline portion located contiguous to the peak portion, and a second basin portion located contiguous the decline portion; at least one bearing received in the circumferentially-oriented pathway; a bias member configured to apply a bias toward the bearing to maintain the bearing onto the circumferentially-oriented pathway; and the bias member being adjustable to affect an amount of bias applied to the bearing.

Additional features and advantages of the clutch assembly will become apparent to those skilled in the art upon consideration of the following detailed description of the illustrated embodiment exemplifying the best mode of carrying out the clutch assembly as presently perceived.

### BRIEF DESCRIPTION OF DRAWINGS

The present disclosure will be described hereafter with reference to the attached drawings which are given as non-limiting examples only, in which:

FIG. 1 is a partially exploded perspective view of a jack leg assembly;

FIG. 2 is an exploded perspective view of a clutch assembly;

FIG. 3 is a partial cross-sectional view of the clutch assembly;

FIG. 4 is another partial cross-sectional view of the clutch assembly;

FIG. 5 is a top partial cross-sectional detail view of a portion of the clutch assembly of FIG. 2;

FIG. 6 is a side cross-sectional view of the portion of the clutch assembly of FIG. 5 taken along lines C-C; and

FIG. 7 is a side sectional projection view of a portion of the channel portion of the clutch assembly.

Corresponding reference characters indicate corresponding parts throughout the several views. The exemplification set out herein illustrates embodiments of the clutch assembly, and such exemplification is not to be construed as limiting the scope of the clutch assembly in any manner.

### DETAILED DESCRIPTION OF THE DRAWINGS

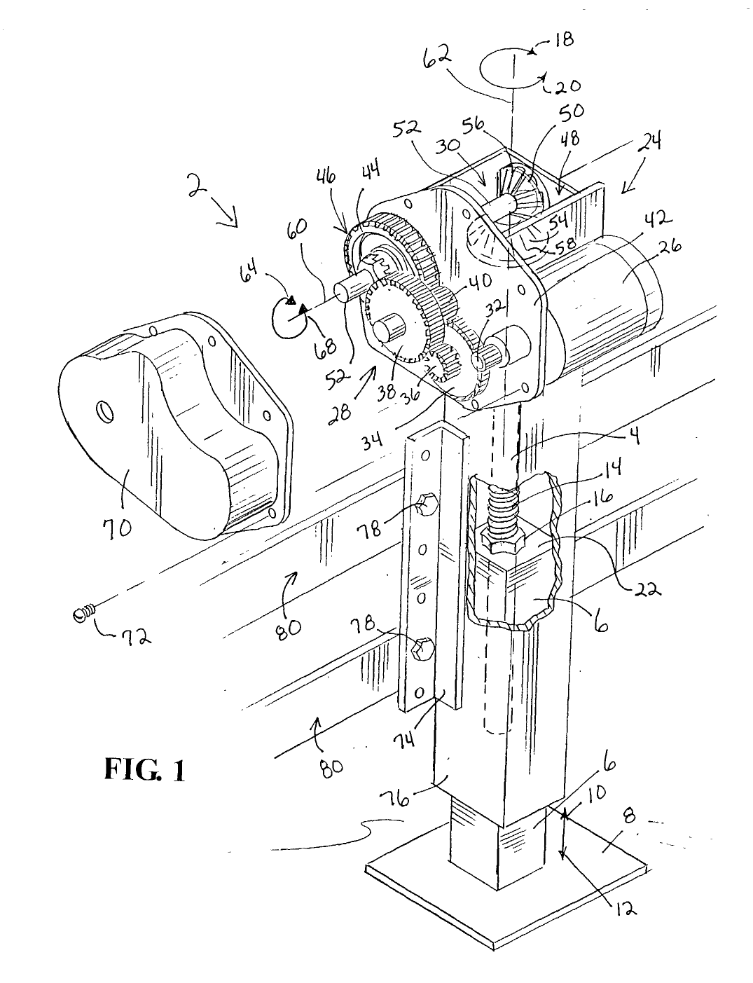

A perspective view of an illustrative embodiment of a jack-leg assembly 2 is shown in FIG. 1. Such leg assemblies 2 are typically used in combination with leveling systems on vehicles like trailers and campers. Leg assembly 2 comprises an outer telescoping member 4 and a corresponding inner telescoping member 6 disposed within outer telescoping member 4 as illustratively shown. A foot pad 8 is attached to the lower-most extent of inner telescoping member 6, and is configured to engage the ground when the assembly 2 is extended. Assembly 2 is moveable between extended and retracted positions, wherein the inner telescoping leg is illustratively moveable within the outer telescoping member in direction 10 to the retracted position. Conversely, the inner telescoping member 6 is moveable in direction 12 to the extended position wherein the foot pad 8 engages the ground surface. The inner telescoping member 6 is moveable within the outer telescoping tube 4, illustratively, via jack screw 14 and nut 16, or comparable extending device, such that as the jack screw 14 turns, it engages nut 16 which is fixed to inner telescoping member 6, causing the same to move in directions either 10 or 12, depending on the rotational direction of the jack screw 14 in directions either 18 and 20.

For example, when the jack screw 14 is rotated in direction 18, the nut 16 which is illustratively attached to the top surface 22 of the inner telescoping member 6 causes same to climb up the jack screw 14, thus, moving the inner telescoping member 6 in direction 10 towards the retracted position. Conversely, when jack screw 14 is rotated in direction 20, the nut 16 is moved downwardly along jack screw 14, causing inner telescoping member 6 to extend towards the downward or extended position in direction 12 to the ground surface.

It is appreciated that the disclosure herein, as it relates specifically to jack leg assembly 2, is for illustrative purposes only. It is contemplated that the clutch assembly disclosed herein may be applicable to any mechanism or assembly that uses drive and driven members for movement.

Drive assembly 24, also shown in FIG. 1, is the mechanism by which the illustrative jack screw 14 is rotated to move inner telescoping leg 6 in directions 10 and 12. In this illustrative embodiment, assembly 24 comprises a motor 26, a gear array 28, and a beveled gear assembly 30. Illustratively, motor 26 rotates gear 32 of array 28. Gear 32 engages other illustrative gears 34, 36, 38, and 40 which are disposed on plate 42, and which ultimately rotate torque limiting gear 44 of clutch assembly 46. Beveled gear assembly 30 is disposed within a cavity 48 which is disposed in outer telescoping member 4 with a vertically-oriented gear 50 attached to a drive shaft 52, and a horizontally-oriented beveled gear 54 that is illustratively attached to jack screw 14. In the illustrated embodiment, the beveled gear teeth 56 of the vertically-oriented beveled gear 50 engages the corresponding beveled teeth 58 of the horizontally-oriented beveled gear 54, such that as motor 26 causes gear 32 to rotate, torque limiting gear 44 is also caused to rotate, driving drive shaft 52. This causes teeth 56 of the vertically-beveled gear 50 to rotate and engage the corresponding teeth 58 of the horizontally-beveled gear 54, thereby transferring rotation about a horizontally-oriented axis 60 to rotation of a vertically-oriented axis 62. In the illustrative embodiment, therefore, rotation caused by motor 26 will cause drive shaft 52 to rotate in either direction 64 or 68, thereby causing the jack screw 14 to correspondingly rotate in either direction 18 or 20.

In the illustrated embodiment, a housing 70, shown in exploded view relative to assembly 2 in FIG. 1, is configured to shroud gear assembly 28 to protect same from contamination which may impair performance and/or cause damage to the gears over time. In this embodiment, housing 70 is shown to be attached to assembly 2 via bolts 72 that engage plate 42, securing housing 70 to assembly 2. Also shown in FIG. 1 is a fastening bracket 74 which is illustratively attached to the outer surface 76 of outer telescoping tube 4. In this embodiment, bracket 74 is illustratively an L-bracket, wherein bolts 78 are disposed through both the bracket 74 and frame members 80. It is appreciated, however, that bracket 74 may be of any configuration suitable to attach assembly 2 onto a frame or other appropriate structure, making bracket 74 itself only an illustrative embodiment.

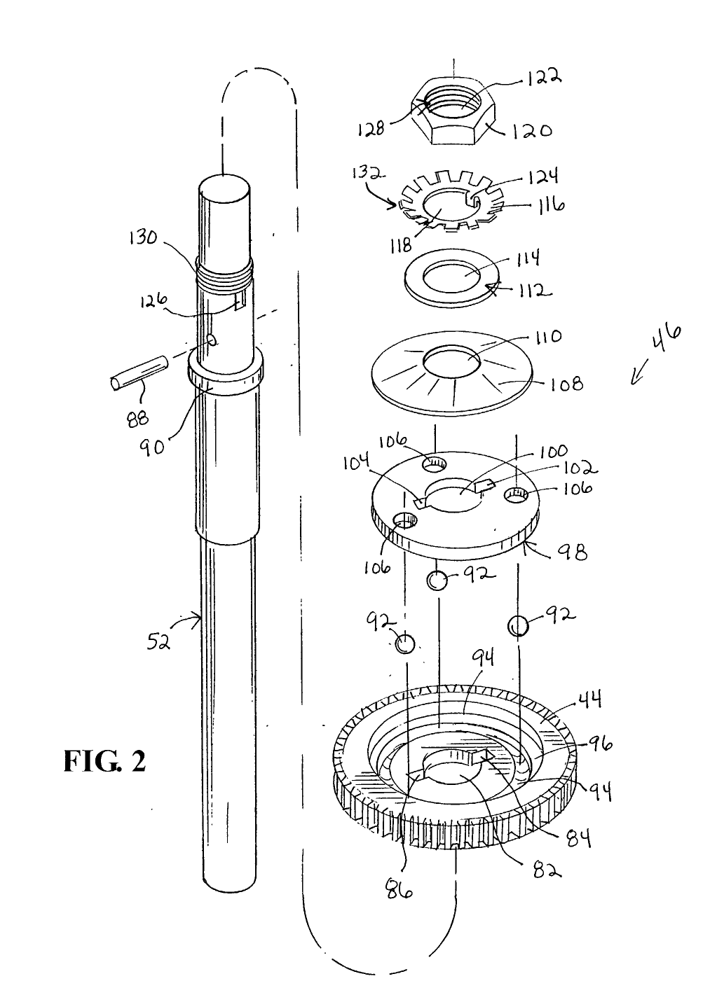

An exploded view of the clutch assembly 46 is shown in FIG. 2. As illustratively shown, a portion of drive shaft 52 extends through hole 82 of torque limiting gear 44. Adjacent hole 82 are illustratively two key ways 84 and 86. These key ways 84 and 86 allow drive shaft 52 to extend through hole 82 such that gear 44 will pass over spline 88 and rotatably-seat adjacent collar 90. Illustratively, three bearings 92 are positioned within channel 94 which is disposed in surface 96 of torque limiting gear 44 as shown. A bearing retainer 98 faces channel 94 and also contains a hole 100 disposed therethrough that is of similar configuration to hole 82 in gear 44. Hole 100 also has key ways 102 and 104 extending therefrom, similar to key ways 84, 86 of gear 44. In this illustrative embodiment, key ways 102 and 104 are configured to engage spline 88 as drive shaft 52 is disposed through hole 100 such that as drive shaft 52 rotates, spline 88 causes bearing retainer 98 to rotate concurrently with drive shaft 52. A plurality of bearing retaining bores 106 are disposed through retainer 98 and are complimentarily-sized to receive at least a portion of bearing 92. Retaining bores 106 are configured to maintain bearings 92 in the illustrative circularly-oriented channel 94.

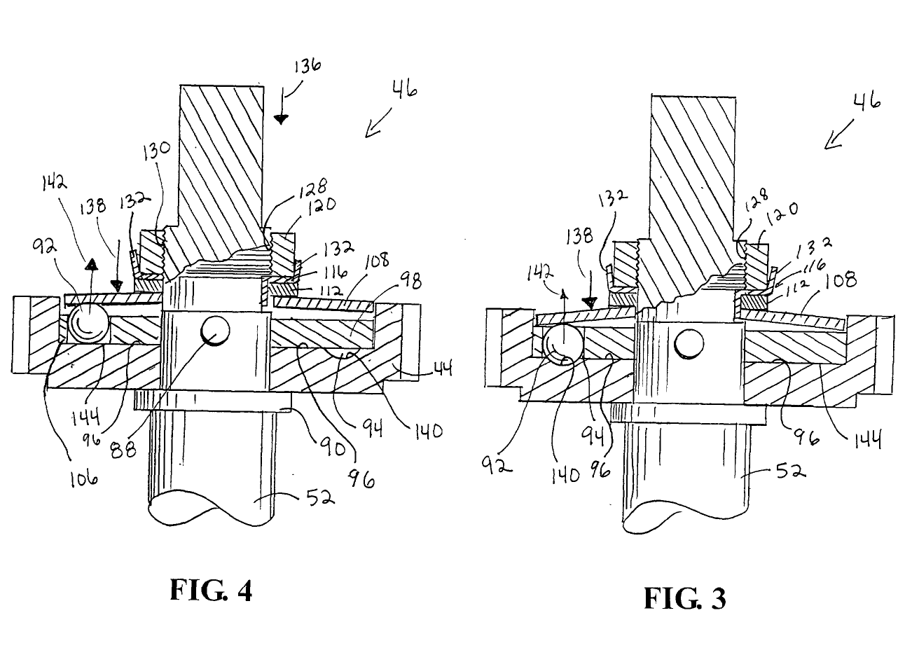

In this illustrative embodiment, a disk spring 108, having a bore 110, through which drive shaft 52 is extended, is configured to be positioned adjacent the bearings 92 as also shown in FIGS. 3 and 6. Disk spring 108 provides the bias against bearings 92 to maintain the same adjacent channel 94. Thrust washer 112 along with locking washer 116 and torque adjusting nut 120 are all configured to secure disk spring 108 adjacent bearings 92.

Specifically, bores 114 of thrust washer 112, bore 118 of locking washer 116, and bore 122 of torque adjusting nut 120 are configured to receive drive shaft 52. The locking washer 116 has a tang 124 that is configured to be positioned in detent 126 of drive shaft 52 to prevent rotational movement of locking washing 116. Bore 122 of torque adjusting nut 120 comprises a threaded surface 128 that is configured to mate with corresponding threads 130 disposed on the outer surface of drive shaft 52 as shown in FIG. 2. Additionally, in the illustrated embodiment, the outer spokes 132 of locking washer 116 are configured to engage torque adjusting nut 120, again, limiting the movement of locking washer 116.

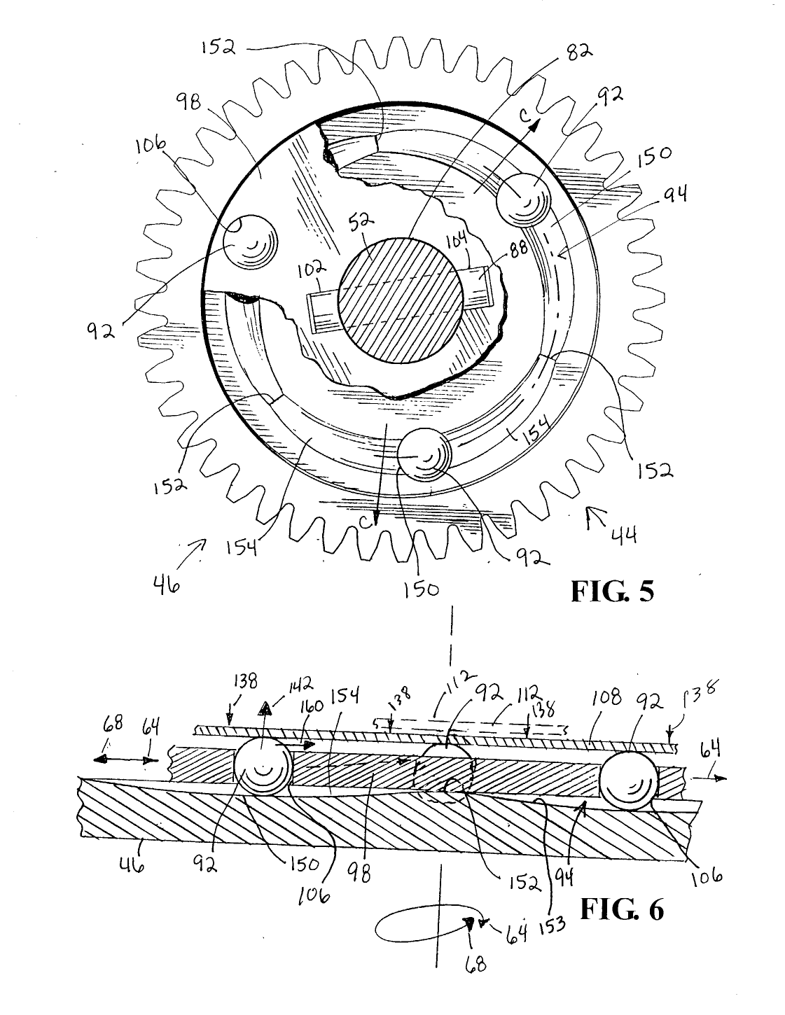

A side cross-sectional view of clutch assembly 46 is shown in both FIGS. 3 and 4. Torque adjusting nut 120 is specifically shown threaded onto the complimentarily-threaded portion 130 of drive shaft 52, along with locking washer 116, having spokes 132 positioned adjacent torque adjusting nut 120, and thrust washer 112 is located between locking washer 116 and disk spring 108. In an illustrative embodiment, as torque adjusting nut 120 is further disposed on threads 130 of drive shaft 52 in direction 136, more pressure is applied against disk spring 108. Disk spring 108 itself applies additional force against bearing 92, with the force indicated by reference number 138, such that as more force 138 is applied to bearing 92, the more bearing 92 will tend to remain within channel 94 at increased torque thresholds. (See FIG. 5.) As specifically shown in FIG. 3, the force 138 of disk spring 108 is maintaining bearing 92 within the lower-most extent 140 of channel 94. In this case, a minimal amount of torque is being applied by the rotation of drive shaft 52 such that bearing 92 is maintained in channel 94. In contrast, FIG. 4 shows an opposite side cross-sectional view of clutch assembly 46, such that as more torque is applied by the rotation of gear 44, bearing 92 is tending to want to move in the direction of force 142 which is opposite the bias force 138 caused by the disk spring and opposite the direction 136, as previously discussed, causing the bearing to move farther up in incline, as shown in FIG. 6, until it reaches a peak 144, as shown in FIG. 4, just prior to the moment the torque created by the gear reaches its threshold.

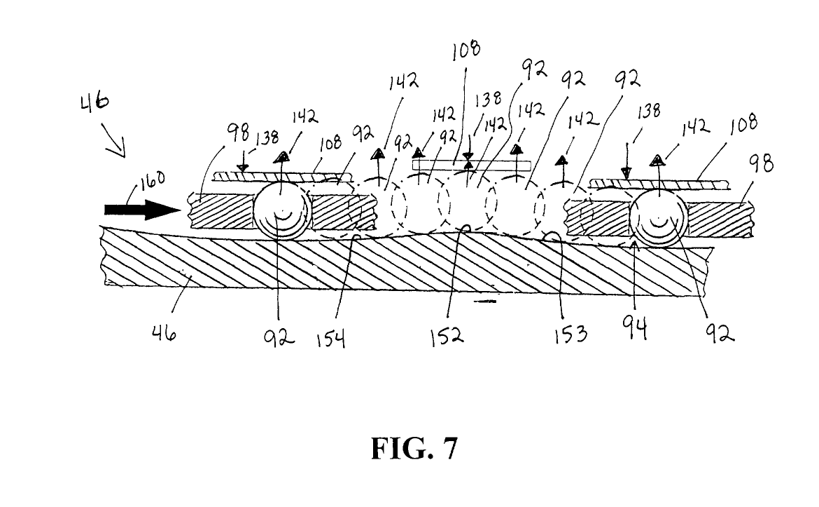

A top, partially cut-away detailed view of clutch assembly 46 is shown in FIG. 5. In an illustrative embodiment, bearings 92 are located in the circular channel 94. As specifically shown, bearings 92 are each located at the basin portion 150 of channel 94, illustratively indicating that the assembly 46 is at a state of low torque. Bounding each end of basin 150 of channel 94 are crest portions 152 which bound the basin portion 150 by gradually-sloping section or incline 154) and decline portion 153 (which also can be referred to as an incline depending on the point of view. (See also FIG. 7.) It is contemplated that bearing retainer 98 along with bearings 92 are rotatively moveable with respect to channel 94, such that bearings 92 are moveable along channel 94.

A cross-sectional view of a portion of assembly 46 is shown in FIG. 6. In the illustrative embodiment, as gear 44 rotates in either direction 64 or 68, the resulting torque is exerted onto bearings 92. Specifically, as gear 44 rotates, the bias force 138 of the disk spring 108 is exerted against bearings 92 with force 142 exerting a counter-force against the disk spring 108 bias force 138. And because at least a portion of each of the bearings 92 is disposed through bearing retainer 98, the bearings 92 cause the bearing retainer 98, and ultimately the drive shaft 52, to rotate concurrently with gear 44. As torque is increased, however, by gear 44, the additional torque applied to bearings 92 causes an increase in force 142, causing the bearings 92 to move further in direction 160.

A projection view of channel 94 depicts the progression of one of the bearings 92 along channel 94 as torque is increased and eventually overloads assembly 46 is shown in FIG. 7. As torque increases, the force on bearing 92 causes an increase in the force 142 against bias force 138 of the disk spring 108, causing the bearing 92 to move further in direction 160, wedging further between disk spring 108 and the incline or sloped portion 154 of channel 94. This continued movement up the sloped portion 154 of channel 94 will be maintained until the point each of the bearings reaches the crest portion 152 at a particular torque threshold. (This is depicted in FIG. 7 by the movement of bearing 92 as drawn in phantom.) When the torque threshold reaches a point beyond its tolerances, the force in direction 142 then becomes greater than the bias force 138 exerted on bearing 92 by disk spring 108. Disk spring 108 can no longer create a wedge for the bearing between itself and channel 94. This allows bearing 92 to move over the crest 152 to decline 153. Accordingly, retainer 98 will no longer move concurrently with gear 44. Rather, gear 44 will continue to rotate, but bearing 92, because of the increased torque beyond the tolerance of the system, will continue to ride along channel 94 until such point the torque is released and bearing 92 can again proceed to wedge between disk spring 108 and the basin 150 or incline surface 154 of channel 94.

Specifically, when the torque threshold is exceeded, the motion of bearing 92 traverses or passes over crest 152 and then down the decline surface 153 on the other side of crest 152 allowing, in essence, the bearing retainer, as well as the drive shaft 52, to discontinue rotating while gear 44 continues rotating. This provides a level of protection to the clutch assembly, while at the same time such movement over the inclines and crests and basins 154, 152, and 150, respectively, prevents substantial impact forces against any of the associated components within assembly 46. Such disengagement of the driven and drive members under substantial load may, thus, be accomplished without damaging those components because the hammering is eliminated or reduced.

It is appreciated that in this illustrative embodiment, gear 44 is being powered or rotated by a motor 26, and incorporates the bearings 92 and the retainer 98 to cause drive shaft 52 to selectively rotate as a consequence. It is appreciated, however, that the opposite may be the case wherein a motor or other driver causes drive shaft 52 to rotate, causing corresponding disk spring bearings and channels to cause rotation of gear 44. In this illustrative embodiment, as drive shaft 52 is torque overloaded, the bearings will no longer wedge against the disk spring and will move along the basins and crests of the channel, thereby preventing movement of gear 44 while drive shaft 52 continues to rotate. It is further appreciated that the configuration of channel 94 and the sizes of the crest's slope or inclines and basins are for illustrative purposes only.

It is further appreciated that, even though the illustrated embodiment depicts a disk spring 108 which can flex as the force 142 of bearing 92 overcomes the bias force 138, other structures may be used in place of disk spring 108 to create the bias against the bearings. For example, a rigid structure can be placed in the same location as, and in lieu of, disk spring 108, wherein the rigid structure includes a coil spring acting thereon to create the bias force against the bearings.

Other configurations of said portions may be employed to allow disengagement between the drive and the driven members without the bearings or other such structures creating high-force impacts against any of the components of the clutch assembly while clutching. This can be particularly useful when dealing with heavy loads such that impact forces that might otherwise be applied to the bearings against structures, like the channel or the disk spring or the bearing retainer, may suffer severe damage because of the substantial torque that is applied to those bearings during overload.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A clutch assembly comprising:
a first rotatable member;
wherein the first rotatable member comprises a pathway disposed thereon;
wherein the pathway having at least one rise and at least one vale;
wherein the rise is adjacent the vale;
a second rotatable member engagable with the first rotatable member;
at least one bearing;
wherein a portion of the bearing is positioned on the circular pathway and is movable along the pathway;
a retainer attached to the second rotatable member;
wherein the retainer receives at least a portion of the at least one bearing such that as the bearing moves along the pathway the retainer maintains receipt of at least a portion of the at least one bearing; and
a bias member located adjacent at least a portion of the at least one bearing such that bias from the bias member is directed against the at least one bearing to maintain the at least one bearing substantially on the pathway.

2. The clutch assembly of claim 1, wherein the bias member is a disk spring.

3. The clutch assembly of claim 1, wherein the bias created by the bias member is adjustable.

4. The clutch assembly of claim 1, wherein the pathway is a circular pathway disposed on the first rotatable member.

5. The clutch assembly of claim 1, wherein the at least one bearing is movable along the rise of the pathway as torque is applied to the assembly.

6. The clutch assembly of claim 1, wherein the pathway comprises a peak located adjacent the rise, wherein the at least one bearing traverses the peak when a maximum torque for the assembly is reached.

7. The clutch assembly of claim 1, wherein the pathway comprises a plurality of successive vales, rises and peaks.

8. A clutch assembly comprising
first and second bodies;
wherein the first body is movable relative to the second body;
a wedge assembly comprising;
a base wedge portion being an inclined plane that is located adjacent the first body;
a bias member having a bias force directed toward the base wedge portion;
a bearing positioned between the base wedge portion and the bias member;
wherein a force exerted on the bearing caused by movement of the first body causes the bearing to become movable along the inclined plane in resistance to the bias force of the bias member.

9. The clutch assembly of claim 8, wherein the bias member is a disk spring.

10. The clutch assembly of claim 8, wherein the bias force created by the bias member is adjustable.

11. The clutch assembly of claim 8, wherein the inclined plane defines a rolling pathway.

12. The clutch assembly of claim 8, wherein the force exerted on the bearing is torque such that as more torque is applied to the assembly, the more the bearing becomes movable along the inclined plane in resistance to the bias force of the bias member.

13. The clutch assembly of claim 8, wherein the base wedge portion comprises a plurality of consecutively positioned basins, inclined planes, and peaks.

14. The clutch assembly of claim 8, comprises a peak located adjacent the rise, wherein the at least one bearing traverses the peak when a maximum torque for the assembly is reached.

15. A clutch assembly comprising:
first and second movable members;
wherein the first movable member is movable relative to the second movable member;
an intermediate member located adjacent the first movable member;
a bias structure located adjacent the intermediate member;
wherein the bias structure creates a bias force directed to the intermediate structure to maintain same adjacent the first movable member;
a means for the first movable member to selectively engage the second movable member to move both first and second movable members concurrently;
a means for receiving the intermediate structure such that after a maximum threshold has been reached by the clutch assembly, the first and second movable members are disengaged without causing the intermediate member to disengage from the first movable member.

16. The clutch assembly of claim 15, wherein the means for receiving the intermediate structure and bias structure prevents the intermediate structure from creating high impact forces against the first movable member when the clutch assembly reaches the maximum threshold.

17. The clutch assembly of claim 15, wherein the means for receiving the intermediate structure and bias structure prevents the intermediate structure from hammering when the clutch assembly reaches the maximum threshold.

18. A clutch assembly having a movable member comprising:
a circumferentially-oriented pathway disposed onto the movable member;
wherein the pathway having a basin portion, an incline portion located contiguous to the basin portion, and a peak portion located contiguous to the incline portion.

19. The clutch assembly of claim 18, wherein the circumferentially-oriented pathway further comprises a decline portion located contiguous to the peak portion, and a second basin portion located contiguous the decline portion.

20. The clutch assembly of claim 18, further comprising at least one bearing received in the circumferentially-oriented pathway.

21. The clutch assembly of claim 20, further comprising a bias member configured to apply a bias toward the bearing to maintain the bearing onto the circumferentially-oriented pathway.

22. The clutch assembly of claim 21, wherein the bias member is adjustable to affect an amount of bias applied to the bearing.
